(19) United States
(12) Patent Application Publication
(10) Pub. No.: US 2026/0233388 A1
(43) Pub. Date: Aug. 13, 2026

(54) TRAINING VISION-LANGUAGE NEURAL NETWORKS FOR REAL-WORLD ROBOT CONTROL

(71) Applicant: Google LLC, Mountain View, CA (US)

(72) Inventors: Yevgen Chebotar, San Francisco, CA (US); Tianhe Yu, Mountain View, CA (US); Quan Ho Vuong, Palo Alto, CA (US); Teddey Ming Xiao, Mountain View, CA (US); Fei Xia, Santa Clara, CA (US); Brian Ichter, Brooklyn, NY (US); Keerthana P G, San Francisco, CA (US); Krzysztof Marcin Choromanski, Lincroft, NJ (US); Isabel Leal, Bellevue, WA (US); Lisa Seung-Yeon Lee, Mountain View, CA (US); Peter Raymond Florence, San Francisco, CA (US); Danny Michael Driess, Berlin (DE); Yao Lu, Palo Alto, CA (US); Sergey Vladimir Levine, Berkeley, CA (US); Karol Hausman, San Francisco, CA (US); Igor Mordatch, Oakland, CA (US); Nikhil J Joshi, Mountain View, CA (US)

(21) Appl. No.: 19/154,432

(22) PCT Filed: Jul. 17, 2024
(86) PCT No.: PCT/US2024/038373

§ 371 Date: Aug. 7, 2025

Related U.S. Application Data
(60) Provisional application No. 63/527,283, filed on Jul. 17, 2023.

(51) Int. Cl. B25J 9/16

(52) U.S. Cl. CPC B25J 9/163; B25J 9/161; B25J 9/1697

(57) ABSTRACT

Methods, systems, and apparatus, including computer programs encoded on a computer storage medium, for controlling an agent interacting with an environment. In one aspect, a method comprises: receiving a user text sequence that characterizes a robotic task to be performed by the agent in the environment; converting the user text sequence into an input text sequence in a standardized format for a visual language understanding task; obtaining an observation image characterizing a state of the environment; processing (i) the input text sequence in the standardized format and (ii) the observation image using a policy neural network to generate a policy output that defines an action to be performed by the agent in response to the observation image; selecting an action to be performed by the agent using the policy output; and causing the agent to perform the selected action.

### CROSS-REFERENCE TO RELATED APPLICATION

This application claims priority to U.S. Provisional Application No. 63/527,283, filed on Jul. 17, 2023. The disclosure of the prior application is considered part of and is incorporated by reference in the disclosure of this application.

### BACKGROUND

This specification relates to controlling agents using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that controls an agent, e.g., a robot, that is interacting in an environment by selecting actions to be performed by the agent and then causing the agent to perform the actions.

The subject matter described in this specification can be implemented in particular embodiments so as to realize one or more of the following advantages.

By representing instructions to an agent in a standardized format for processing by a policy neural network to generate policy outputs for determining actions to be performed by the agent, the system can use a policy neural network that incorporates knowledge gained from large-scale datasets, e.g., knowledge gained as a result of large-scale pre-training on language and/or vision-language training datasets from the web, to perform end-to-end robotic control. Making use of such a policy neural network can boost the generalization capability of the policy neural network to broadly cover a wider range of robotic tasks, as well as to enable emergent capabilities, namely new capabilities beyond those demonstrated in the robotics training datasets, such as symbol understanding, visual and/or multilingual reasoning, and human recognition, to further enhance the performance of the robot on these tasks.

More specifically, this specification describes techniques for representing robot actions as text tokens that fit into the configuration of any of a variety of state-of-the-art, pre-trained vision-language model neural networks. This specification also describes techniques for training such a vision-language model on training inputs selected from both robotics training datasets and web-scale vision-language training datasets, e.g., instead of solely on robotics training datasets, to improve the effectiveness of the training process and generalization capability.

A policy neural network trained using the described techniques can generalize well to new tasks or new environments or both, e.g., to control a robot to manipulate novel objects; interpret commands that were not present in the robot training data, e.g., to place an object onto a particular number or icon; and perform rudimentary reasoning in response to commands, e.g., to pick up the smallest or largest object, or the object closest to another object. The system can generalize to unseen objects, backgrounds and environments. The described techniques also enhances the robot's ability to follow natural language instructions/commands.

From another point of view, the techniques described in this specification can train the policy neural network to perform well across a greater range of tasks using less data and fewer computational and memory resources than some other approaches. Those techniques typically train a policy neural network by relying on robotics training datasets that include images of all objects and environments that might be encountered and/or all commands that might be given at inference. Thoroughly generating such datasets is time-consuming and computationally costly.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example policy system and an example control system.

FIG. 2 shows an example training system.

FIG. 3 is a flow diagram of an example process for training a vision-language model (VLM) neural network.

FIG. 4 is an illustration of operations performed to train a vision-language model (VLM) neural network.

FIG. 5 is a flow diagram of an example process for controlling an agent interacting with an environment.

FIG. 6 shows a quantitative example of the performance gains that can be achieved by using a policy system described in this specification.

Like reference numbers and designations in the various drawings indicate like elements.

### DETAILED DESCRIPTION

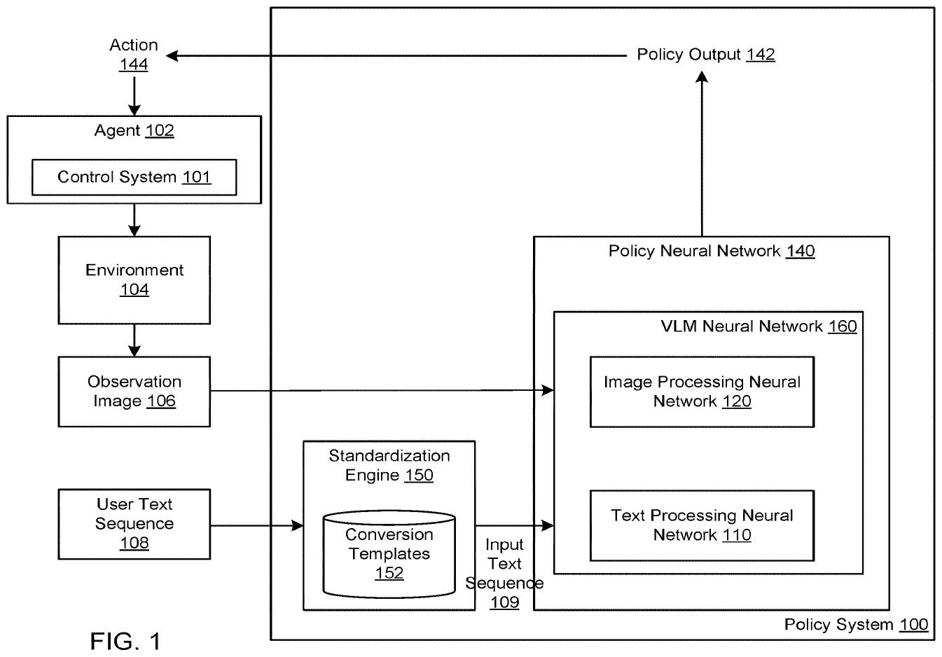

FIG. 1 shows an example policy system 100 and an example control system 101. The policy system 100 and the control system 101 are examples of systems implemented as computer programs on one or more computers in one or more locations in which the systems, components, and techniques described below are implemented.

The policy system 100 and the control system 101 can control an agent 102, e.g., a robot, to accomplish any of a wide variety of tasks in the environment 104. To control the agent 102 that is interacting in the environment 104 to accomplish a task, the policy system 100 selects actions 144 to be performed by the agent 102, and the control system 101 then causes the agent 102 to perform the selected actions 144.

As a general example, the task can include one or more of, e.g., causing the agent to navigate to different locations in the environment and avoiding obstacles along the way, causing the agent to locate different objects, causing the agent to pick up different objects or to move different objects to one or more specified locations, and so on. To accomplish such a task, the agent 102 moves, e.g., navigates and/or changes its configuration, within the environment 104.

Typically, the control system 101 is local to the agent 102. For example, the control system 101 can be on-board the agent 102, e.g., can be implemented on one or more computers, a local workstation, or a local server having relatively small processing and memory resources that is on-board the agent 102, e.g., having limited processing power and/or a constrained memory space.

In some implementations, the policy system 100 is local to the agent 102. For example, like the control system 101, the policy system 100 can also be on-board the agent 102. Moreover, in some of these implementations, the policy system 100 can be a part of the control system 101 which causes the agent 102 to perform actions 144.

In other implementations, the policy system 100 is remote from the agent 102. For example, unlike the control system 101, the policy system 100 can be hosted within a data center, which can be a distributed computing system having hundreds or thousands of computers in one or more locations. That is, the control system 101 can receive data identifying the actions 144 from an external source, e.g., rather than generating such data on-board the agent 102.

In these implementations, the policy system 100 and the control system 101 can be connected by a data communication network, such as a local area network (LAN), a wide area network (WAN), the Internet, or a combination thereof.

In these implementations, the control system 101 of the agent 102 interacts with a remote policy system 100 that is hosted within a data center with much more computing and other resources than those available on-board the agent 102 to reduce the latency in selecting actions 144, reduce the consumption of the limited power supply of the agent 102 when selecting actions 144, or both.

In some implementations, the policy system 100, the control system 101, or both can expose one or more application programming interfaces (APIs) or other data interfaces that facilitate the control of the agent 102. For example, a user of the agent 102 may use an API made available by the action selection system 100 to provide natural language text sequences 108 characterizing the tasks to be performed by the agent. As another example, the policy system 100 and the control system 101 can interact through an API between the two systems, e.g., the control system 101 can use the API to provide the observation image 106 to the policy system 100, and the policy system 100 can use the API to provide data specifying the selected actions 144 to the control system 101.

In particular, the policy system 100 and the control system 101 control the agent based on policy outputs 142 generated by a policy neural network 140 that has been configured through training to control the agent 102 in response to observation images 106 characterizing the environment 104 and natural language text sequences 108 characterizing the task to be performed by the agent 102.

For example, the observation images 106 can include images captured by a visual sensor of the agent 102 or by a visual sensor located in the environment 104. The visual sensor can for example be a camera, e.g., a still camera or a video camera, a depth camera, or a lidar sensor. At each of a plurality of time steps, the policy system 100 can obtain an observation image 106 characterizing a state of the environment 104 at the time step.

The policy system 100 receives a user text sequence 108 in a natural language that characterizes a robotic task to be performed by the agent 102 in the environment 104 and uses a standardization engine 150 to convert the user text sequence 108 into an input text sequence 109 in a standardized format for a visual language understanding task. This input text sequence 109 in the standardized format is then provided to the policy neural network 140.

The user text sequences 108 can be received by the policy system 100 in various ways, including from another agent in the environment 104 or from the control system 101 of the agent 102. For example, another agent in the environment 104 can speak an instruction and the control system 101 or another system can transcribe it into a user text sequence 108, and then provide the transcription to the policy system 100. As another example, the control system 101 can receive an instruction, e.g., a text-based input, a selection-based input, or an audio-based input, entered by a user that specifies the user text sequence 108, and then provide the instruction to the policy system 100. As another example, the control system 101 can receive a brain signal input or some other bodily input, e.g., a gesture input, a lip movement input, or a gaze input, that defines or otherwise specifies the instruction, and then provide the instruction to the policy system 100.

The standardization engine 150 formats the user text sequences 108 into a standardized format for one or more visual language understanding tasks to generate the input text sequence 109. In principle the visual language understanding tasks can include any one or more of multi-modal understanding tasks that require a neural network to process an input that includes data from a textual modality and data from a visual modality to generate an output for the tasks.

For example, the visual language understanding tasks can include a visual question answering (VQA) task, and an input to the neural network can include one or more images and a text question about the one or more images, and an output of the neural network can be an answer to the text question.

As another example, the visual language understanding tasks can include an image captioning task that requires generating a text caption for an image.

As another example, the visual language understanding tasks can include an open-vocabulary object detection task, where the neural network is configured to receive an input tuple including an image and a text sequence for the image, which may be a sequence of words in a natural language that describes an object of interest, and to process the network input to generate an open-vocabulary object detection output that specifies whether the image includes a depiction of the object of interest and if so, where the object of interest is located within the image.

As another example, the visual language understanding tasks can include two or more of the visual question answering (VQA) task, the image captioning task, or the open-vocabulary object detection task as mentioned above, and possibly other multi-modal understanding tasks.

The standardization engine 150 maintains, for each visual language understanding task, one or more predetermined conversion templates 152 that correspond the visual language understanding task. Upon receipt of a user text sequence 108, the standardization engine 150 selects a conversion template from among the predetermined conversion templates 152, and converts the user text sequence 108 in accordance with the selected predetermined conversion template to generate the input text sequence 109.

Thus, the input text sequence 109 has a standardized format that corresponds to one of the visual language understanding tasks. The standardized format can be a combination of (i) a predetermined text sequence that is defined by a conversion template 152 and (ii) the user text sequence 108. In implementations, the predetermined text sequence and the user text sequence 108 can be combined in any order. For example, the predetermined text sequence can be prepended to, appended to, or interleaved within the user text sequence 108.

In the example where the visual language understanding is a visual question answering (VQA) task, the predetermined text sequence defined by a corresponding conversion template 152 can, for example, be “Q: what action should the robot take to ┌ . . . ┐? A:” where [ . . . ] will be replaced by the user text sequence 108 or a portion of the user text sequence 108. In this example, because the predetermined text sequence defines a text question, a user text sequence 108 can be formatted into an input text sequence 109 that has a question format, which is similar to the format of the inputs that would be received by a neural network for VQA tasks.

In the example where the visual language understanding is an image captioning task, the predetermined text sequence defined by a corresponding conversion template 152 can, for example, be “describe the content of this image.” which will be appended by the user text sequence 108 or a portion of the user text sequence 108. In this example, because the predetermined text sequence defines a natural language instruction, a user text sequence 108 can be formatted into an input text sequence 109 that has an instructional format, which is similar to the format of the inputs that would be received by a neural network for image captioning tasks.

In the example where the visual language understanding is an open-vocabulary object detection task, the predetermined text sequence defined by a corresponding conversion template 152 can, for example, be “Q: where is [ . . . ] in the image? A:” or “find [ . . . ] in this image.” where [ . . . ] will be replaced by the user text sequence 108 or a portion of the user text sequence 108. In the prior example, a user text sequence 108 can be formatted into an input text sequence 109 that has a question format, while in the latter example, a user text sequence 108 can be formatted into an input text sequence 109 that has an instructional format. Both formats are similar to the formats of the inputs that would be received by a neural network for open-vocabulary image classification tasks.

The policy neural network 140 processes the input text sequence 109 and an observation image 106 using a vision-language model (VLM) neural network 160 to generate a policy output 142. The VLM neural network 160, in turn, includes a text processing neural network 110 and an image processing neural network 120.

The image processing neural network 120 is configured to receive an image encoder input that includes an observation image 106, and process the image encoder input in accordance with the parameters of the image processing neural network 120 to generate an encoded representation of the observation image 106 (or “encoded image” for short).

While this specification generally refers to observations as “observation images,” in some cases the observations can include additional data in addition to image, e.g., proprioceptive data characterizing the agent or other data captured by other sensor of the agent. In these cases, the other data can also be included in the image encoder input in addition to the observation image 106 to be processed by the image processing neural network 120 to generate the encoded image.

Generally, the encoded image includes a respective embedding for each of multiple patches in the observation image 106, e.g., for each of multiple spatial patches (regions) of the observation image 106. An “embedding” as used in this specification is a sequence of one or more vectors of numeric values, e.g., floating point values or other values, each vector having a pre-determined dimensionality.

The image processing neural network 120 can have any appropriate architecture that allows the neural network 120 to map an image encoder input to an encoded image. For example, the image processing neural network 120 can be a convolutional neural network. As another example, the image processing neural network 120 can be a vision Transformer (ViT) neural network that has one or more self-attention layers. As yet another example, the image processing neural network 120 can be a neural network that has a mix of both convolutional and self-attention layers.

The text processing neural network 110 in the VLM neural network 160 is configured to receive a text encoder input that includes the input text sequence 109 and the encoded image that is generate by the image processing neural network 120, and process the text encoder input in accordance with the parameters of the text processing neural network 110 to generate the policy output 142.

The text processing neural network 110 can have any appropriate attention-based architecture, e.g., the architecture of an encoder-only Transformer neural network, an encoder-decoder Transformer neural network, or a decoder-only Transformer neural network, that allows the neural network 110 to map the text encoder input to the policy output 142.

As a particular example, the text processing neural network 110 can include a set of initial neural network layers and a set of subsequent neural network layers. The set of initial neural network layers processes the input text sequence 109 to generate an encoded representation of the input text sequence 109 (or “encoded text” for short), which is then provided, together with the encoded image, to the set of subsequent neural network layers for processing to generate the policy output 142.

Generally, the encoded text includes a respective embedding for each of multiple tokens in the input text sequence 109. The tokens can include any tokens from a predetermined vocabulary of tokens. The predetermined vocabulary of tokens can include any of: characters, subwords, words, punctuation marks, sign tokens (e.g., the #, $, and other signs), mathematical symbols, numbers, and so on.

For example, the set of initial neural network layers can include one or more self-attention layers that each apply a self-attention operation over the input text sequence 109 to generate the encoded text. Unlike the set of initial neural network layers, the set of subsequent neural network layers can include one or more cross-attention layers that each apply a cross-attention operation over the encoded text and the encoded image to generate the policy output 142.

Therefore, in this example, the encoded text generated by the initial neural network layers of the text processing neural network 110 depends only on the input text sequence 109 while the policy output 142 generated by the subsequent neural network layers of the text processing neural network 110 depends on both the observation image 106 and the input text sequence 109.

Examples of architectures of the text processing neural network 110 and the image processing neural network 120 that can be included in the VLM neural network 160 are described in further detail in X. Chen, et al. Pali-x: On scaling up a multilingual vision and language model, 2023 and D. Driess, et al. Palm-e: An embodied multimodal language model. arXiv preprint arXiv:2303.03378, 2023.

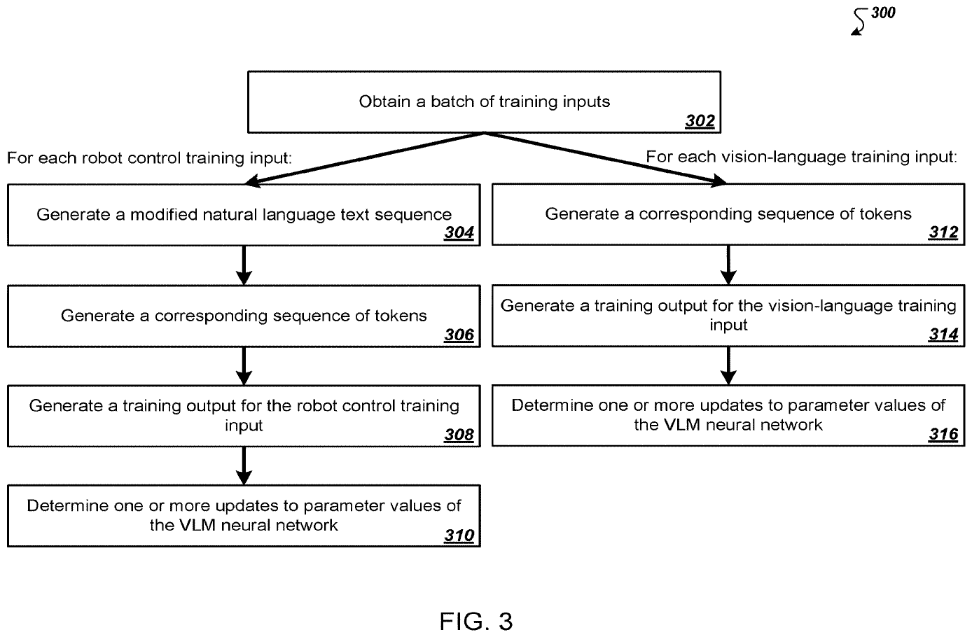

The policy output 142 that is generated by the policy neural network 140 defines an action 144 to be performed by the agent 102 in response to the observation image 106 received at the time step. For example, the policy system 100 can use the VLM neural network 160 to generate the policy output 142 comprising a plurality of tokens generated in an auto-regressive manner by making a plurality of forward passes through the VLM neural network 160. As will be explained further below with reference to FIG. 3, the plurality of tokens can include any tokens in a predetermined subset of the predetermined vocabulary of tokens.

In some implementations, each possible action that can be performed by the agent 102 is defined by a respective value for each of a plurality of action dimensions. In these implementations, for each of the plurality of action dimensions, the policy output 142 can define a respective distribution over possible values for the action dimension.

For example, when the agent 102 is a mobile manipulator robot having a base and one or more arms, where at least one of the arms has an end effector (e.g., a gripper or another tool) attached to its end, the plurality of action dimensions can include 7 action dimensions for arm movement: x, y, z, roll, pitch, yaw, and status of the end effector (e.g., open/close status of the gripper). Optionally, the plurality of action dimensions can also include 3 action dimensions for base movement: x, y, yaw. Optionally, the plurality of action dimensions can further include an action dimension for mode switch (e.g., for switching between controlling an arm of the robot, controlling the base of the robot, or terminating the episode).

In other examples, the agent may be a different type of robot, or it may be a vehicle or another type of agent as mentioned above, and each possible action that can be performed by the agent may thus be characterized by a different set of action dimensions.

In any example, the possible values for each action dimension can be discretized into a fixed number of bins, and the policy output 142 can include one or more tokens that define a distribution over the fixed number of bins for the action dimension. The distribution can be a categorical distribution (a respective discrete probability distribution) that assigns a respective probability score to each bin in the fixed number of bins for the action dimension.

In these implementations, for each action dimension, the fixed number of bins can correspond to about equal number of possible values for the action dimension. For example, the possible values for the roll (or, analogously, pitch, or yaw) action dimension have a range from 0 to 360 degrees, which be divided into 32 bins (each bin corresponding to a range that spans about 11.25 degrees), 128 bins (each bin corresponding to a range that spans about 2.81 degrees), 256 bins (each bin corresponding to a range that spans about 1.41 degrees), or the like, and thus the policy output 142 can include one of 32 tokens that each represent a different bin in the 32 bins, one of 128 that each represent a different bin in the 128 bins, one of 256 tokens that each represent a different bin in the 256 bins, or the like.

As another example, the possible values for the mode switch action dimension are 0 (controlling an arm of the robot), 1 (controlling the base of the robot), and 2 (terminating the episode), which can be divided into 3 bins (each bin corresponding to a respective value), 256 bins (about 85 bins each corresponding to a same respective value), or the like, and thus the policy output 142 can include one of 3 tokens that each represent a different bin in the 3 bins, one of 256 tokens that each represent a different bin in the 256 bins, or the like.

The policy system 100 selects the action 144 to be performed by the agent 102 using the policy output 142. To select the action to be performed by the agent 102 at the time step, the policy system 100 selects, for each of one or more of the action dimensions, a respective value within the possible values for the action dimension using the respective distribution that is defined by one or more tokens included in the policy output 142.

For example, the policy system 100 can greedily select the highest-scoring bin or can sample, e.g., using nucleus sampling or another sampling technique, a bin from the respective distribution defined by the one or more tokens included in the policy output 142 for an action dimension, and then select a value that corresponds to, e.g., falls within, the selected bin as the selected value for the action dimension.

After having selected the action 144 to be performed by the agent 102, the policy system 100 provides data identifying the selected action 144 to the control system 101. In implementations where the policy system 100 is remote from the agent 102, providing the data identifying the selected action 144 can, for example, include transmitting data identifying the selected action 144 over the data communication network that connects the policy system 100 and the control system 101.

The control system 101 then causes the agent 102 to perform the selected action 144, e.g., in response to obtaining the observation image 106 obtained at the time step. For example, the control system 101 can do this by generating instructions for the agent 102 that when executed will cause the agent 102 to perform the selected action 144, by submitting a control input directly to the appropriate controls of the agent, or by using another appropriate control technique.

In some implementations, the environment 104 is a real-world environment and the agent 102 is a mechanical agent interacting with the real-world environment. For example, the agent may be a robot interacting with the environment to accomplish a goal, e.g., to locate an object of interest in the environment, to move an object of interest to a specified location in the environment, to physically manipulate an object of interest in the environment in a specified way, or to navigate to a specified destination in the environment; or the agent may be an autonomous or semi-autonomous land, air, or sea vehicle navigating through the environment to a specified destination in the environment.

The actions 144 may be control inputs to control a robot, e.g., torques for the joints of the robot or higher-level control commands, or the autonomous or semi-autonomous land or air or sea vehicle, e.g., torques to the control surface or other control elements of the vehicle or higher-level control commands.

In other words, the actions 144 can include for example, position, velocity, or force/torque/acceleration data for one or more joints of a robot or parts of another mechanical agent. Actions may additionally or alternatively include electronic control data such as motor control data, or more generally data for controlling one or more electronic devices within the environment the control of which has an effect on the observed state of the environment. For example in the case of an autonomous or semi-autonomous land, air, or sea vehicle the actions may include actions to control navigation, e.g., steering, and movement e.g., braking and/or acceleration of the vehicle.

In some implementations the environment 104 is a simulated environment and the agent 102 is implemented as one or more computer programs interacting with the simulated environment. For example, the environment can be a computer simulation of a real-world environment and the agent can be a simulated mechanical agent navigating through the computer simulation.

For example, the simulated environment may be a motion simulation environment, e.g., a driving simulation or a flight simulation, and the agent may be a simulated vehicle navigating through the motion simulation. In these implementations, the actions 144 may be control inputs to control the simulated user or simulated vehicle. As another example, the simulated environment may be a computer simulation of a real-world environment and the agent may be a simulated robot interacting with the computer simulation.

Generally, when the environment 104 is a simulated environment, the actions 144 may include simulated versions of one or more of the previously described actions or types of actions.

In some implementations, the environment 104 is a suitable execution environment, e.g., a runtime environment or an operating system environment, that is implemented on one or more computing devices such as smart phones, tablet computers, wearable devices, automobile systems, standalone personal assistant devices, and so forth, and the agent 102 is a virtual agent (also known as “automated assistant” or “mobile assistant”) that may be interacted with by a user through the computing devices. The virtual agent can receive input from the user (e.g., typed or spoken natural language input) and respond with responsive content (e.g., visual and/or audible natural language output). The virtual agent can provide a broad range of functionalities through interactions with various local and/or third-party applications, websites, or other agents. In these implementations, the actions 144 may include any activity or operation that may be performed or initiated by the user on a computing device, e.g., within an application software installed on the computing device.

In some cases, the policy system 100 can be used to control the interactions of the agent with a simulated environment, and the policy system 100 (or another training system) can train the VLM neural network 160 included in the policy neural network 140 that is used to control the agent 102 by using one or more robotics training datasets that are based on the interactions of the agent 102 (or another agent) with the simulated environment to determine trained values of the parameters of the VLM neural network 160.

After the VLM neural network 160 has been trained based on the interactions of the agent 102 (or another agent) with a simulated environment, the trained VLM neural network 160 can be used (e.g., as part of the policy neural network 140) by the policy system 100 to control the interactions of a real-world agent with the real-world environment, i.e., to control the agent that was being simulated in the simulated environment.

Training the VLM neural network 160 based on interactions of an agent with a simulated environment (i.e., instead of a real-world environment) can avoid wear-and-tear on the agent and can reduce the likelihood that, by performing poorly chosen actions, the agent can damage itself or aspects of its environment.

The VLM neural network 160 is also trained on a variety of vision-language training datasets. Such vision-language training datasets can include, for example, datasets for the visual question answering task, the image captioning task, and the open-vocabulary object detection task as mentioned above and many other visual language understanding tasks.

Training the VLM neural network 160 on the vision-language training datasets can enable it to incorporate the learned visual language understanding capability into end-to-end robotic control to boost the generalization capability of the VLM neural network 160 to broadly cover a wider range of robotic tasks, as well as to enable emergent capabilities, namely new capabilities beyond those demonstrated in the robotics training datasets, such as symbol understanding, visual and/or multilingual reasoning, and human recognition, to further enhance the performance of the robot on these robotic tasks.

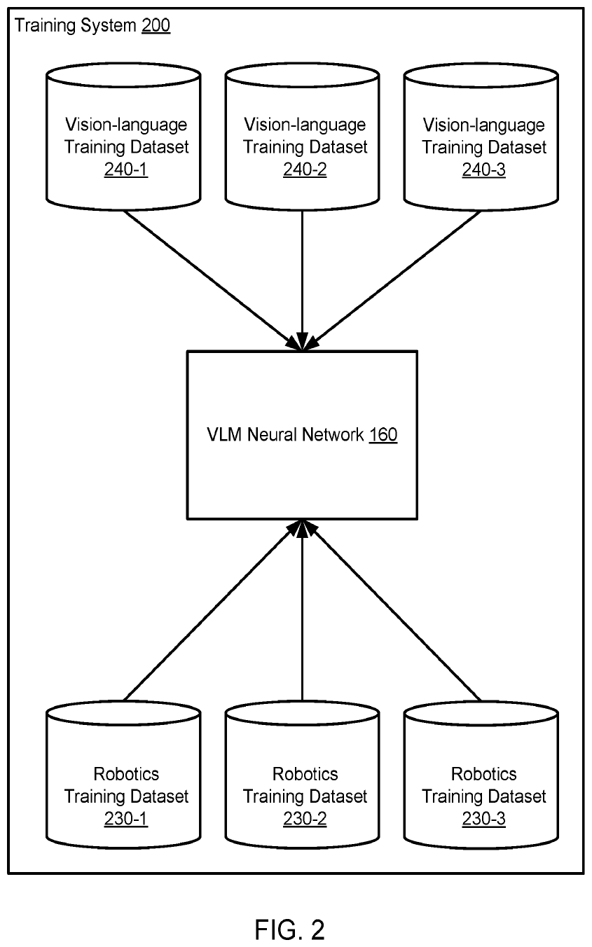

FIG. 2 shows an example training system 200 implemented as computer programs on one or more computers in one or more locations that trains the vision-language model (VLM) neural network 160 on one or more robotics training datasets 230 and one or more vision-language training datasets 240.

Each robotics training dataset 230 includes a plurality of robot control training inputs. Each robot control training input includes (i) an image that characterizes an environment, (ii) a natural language text sequence that characterizes a task to be performed by an agent in the environment, and (iii) a target policy output that defines an action to be performed by the agent.

By way of illustration and not limitation, the robotics training datasets 230 can be, or be generated from, one or more of the datasets discussed in Brohan, Anthony, et al. “Rt-1: Robotics transformer for real-world control at scale.” arXiv preprint arXiv:2212.06817 (2022).

More generally, the robotics training datasets 230 can be generated based on interaction with one or more environments by one or more robots that may not be the same model, located at the same site, or even built by the same manufacturer. In addition, the robotics training datasets 230 do not need to be generated from physical robots. That is, the robotics training datasets 230 can include data generated both from real robots and from simulations of the physical robots.

For example, the robotics training datasets 230 can be generated from tens or hundreds of different robots having different physical characteristics and being different models when performing the same or different robotic control tasks, including object-centric tasks such as object manipulation task and environment navigation tasks. An object manipulation task typically requires picking up, dropping off, and/or otherwise manipulating a target object in the environment; an environment navigation task typically requires avoiding and/or otherwise dealing with obstacles in the environment.

For example, in FIG. 2, the one or more robotics training datasets 230 can include a first robotics training dataset 230-1 that corresponds to an object picking/grasping task (where the natural language text sequence included in a robot control training input can, e.g., have the format of “Pick Object” where Object can be replaced with any object, e.g., bottle, can, apple, strawberry, bowl, bag, and so on), a second robotics training dataset 230-2 that corresponds to an object placement task (where the natural language text sequence included in a robot control training input can, e.g., have the format of “Place Object Upright”), a third robotics training dataset 230-3 that corresponds to an object moving task (where the natural language text sequence included in a robot control training input can, e.g., have the format of “Move Object Near Object”), and so on.

Each vision-language training dataset 240 includes a plurality of vision-language training inputs. Each vision-language training input includes (i) an image, (ii) a natural language text sequence that is paired with the image, and (iii) a target vision-language task output.

By way of illustration and not limitation, the vision-language training datasets 240 can be, or be generated from, one or more of the datasets discussed in the Pali-x: On scaling up a multilingual vision and language model reference and the Palm-e: An embodied multimodal language model reference mentioned above.

More generally, the vision-language training datasets 240 can include any dataset for any visual language understanding task. A visual language understanding task is a multi-modal understanding task that requires a neural network to process an input that includes data from a textual modality and data from a visual modality to generate an output for the task.

For example, in FIG. 2, the one or more vision-language training datasets 240 can include a first vision-language training dataset 240-1 that corresponds to a visual question answering task (where natural language text sequence included in a vision-language training input can, e.g., be a question that is posed about an image also included in the vision-language training input, and the target vision-language task output is an answer to the question), a second vision-language training dataset 240-2 that corresponds to an image captioning task (where the target vision-language task output included in a vision-language training input is a caption of an image included in the vision-language training input), a third vision-language training dataset 240-3 that corresponds to an open-vocabulary object detection task (where natural language text sequence included in a vision-language training input can, e.g., describe a set of object categories, and the target vision-language task output includes a respective score for each of the set of object categories representing an estimated likelihood that an image included in the vision-language training input contains a depiction of an object belonging to the category), and so on. Further examples of the multi-modal understanding task include image-based text retrieval, open-vocabulary image classification task, scene text understanding task, and so on.

The training system 200 performs the training over multiple training iterations. At each training iteration, the training system 200 updates the parameters of the VLM neural network 160 by performing a forward pass through the VLM neural network 160 using a batch of training inputs obtained from (i) the one or more robotics training datasets 230, (ii) the one or more vision-language training datasets 240, or both (i) and (ii), and then performs a backward pass through the VLM neural network 160 to compute respective gradients of a suitable training objective function with respect to the parameters of the VLM neural network 160 through backpropagation.

Thus, by repeatedly performing update iterations, the training system 200 repeatedly updates the parameters of the VLM neural network 160 to determine updated values of the parameters that will cause the VLM neural network 160 to perform well on the tasks that correspond to the datasets.

In particular, the training system 200 trains the VLM neural network 160 to perform well on both the robotic control tasks that correspond to the one or more robotics training datasets 230 and the visual language understanding tasks that correspond to the one or more vision-language training datasets 240. That is, the same VLM neural network 160 is trained across different tasks, e.g., from an object manipulation task that requires generating a policy output defining an action to be performed by an agent in response to an observation image to a task that requires generating an answer to a text question posed about an image.

FIG. 3 is a flow diagram of an example process 300 for training a vision-language model (VLM) neural network on one or more robotics training datasets and one or more vision-language training datasets. For convenience, the process 300 will be described as being performed by a system of one or more computers located in one or more locations. For example, a training system, e.g., the training system 200 of FIG. 2, appropriately programmed in accordance with this specification, can perform the process 300.

The system can repeatedly perform iterations of the process 300 on different batches of training inputs to update the parameters of the VLM neural network. The system can continue performing iterations of the process 300 until termination criteria for the training of the VLM neural network have been satisfied, e.g., until the parameters have converged, until a threshold amount of wall clock time has elapsed, or until a threshold number of iterations of the process 300 have been performed.

In some implementations, the VLM neural network has been pre-trained, and the system performs iterations of the process 300 to train the VLM neural network beginning from pre-trained parameter values learned as a result of the pre-training and rather than from scratch, e.g., from randomly initialized parameter values.

For example, the VLM neural network can have been pre-trained by the training system 200 of FIG. 2 or another training system on one or more of: a visual question answering dataset, an image captioning dataset, a scene text understanding dataset, or another multimodal understanding task pre-training dataset; an object manipulation dataset, an environment navigation dataset, or another robotics pre-training dataset, based on optimizing one or more unsupervised or self-supervised objective functions, e.g., a maximum-likelihood objective function, and, optionally, one or more supervised objective functions.

As a particular example, the VLM neural network can have been pre-trained based on optimizing a next token prediction objective that requires predicting, given an image and a current sequence of text tokens, the next text token that follows the current sequence in a pre-training dataset. For example, the current sequence of text tokens can represent any portion of a caption of the image (in cases where the pre-training dataset is an image captioning dataset) or any portion of an instruction for a robot that defines an action to be performed by the robot in response to an observation image characterizing a state of an environment (in cases where the pre-training dataset is an object manipulation dataset).

The system obtains a batch of training inputs from the one or more robotics training datasets, the one or more vision-language training datasets, or both (step 302). The system will generally obtain different training inputs at different iterations, e.g., by sampling a fixed number of training inputs from the robotics training datasets and/or the vision-language training datasets at each iteration.

In other words, in some cases, at an iteration of the process 300, all of training inputs included in the batch are robot control training inputs. In some other cases, at an iteration of the process 300, all of training inputs included in the batch are vision-language training inputs. In yet other cases, at an iteration of the process 300, some training inputs included in the batch are robot control training inputs while other training inputs included in the batch are vision-language training inputs.

In some implementations, the system maintains a respective weight for each of the one or more robotics training datasets and the one or more vision-language training datasets, and then sample different batches of training inputs from the one or more robotics training datasets and the one or more vision-language training datasets in accordance with their respective weights. Thus, at an iteration of the process 300, the batch of training inputs will more likely include training inputs from training datasets that have greater weights relative to other training datasets.

There are many ways in which the system can determine the respective weights. For example, the system can receive a user input specifying the respective weights from a user of the system. As another example, the system can set the respective weights to default, initial values and then dynamically adjust the respective weights over the course of the iterations of the process 300, e.g., by increasing the respective weights for the one or more robotics training datasets relative to the respective weights for the one or more vision-language training datasets (or vice versa), as a greater number of the iterations of the process 300 are performed.

At each iteration of the process 300, the system performs steps 304-310 for the robot control training inputs included in the batch. Each robot control training input includes (i) an image that characterizes an environment, (ii) a natural language text sequence that characterizes a task to be performed by an agent in the environment in response to the image, i.e., when the environment is in a state characterized by the image and (iii) a target policy output that defines a target action to be performed by the agent in response to the image, i.e., when the environment is in the state characterized by the image.

For each robot control training input, the system generates, from a natural language text sequence included in the robot control training input, a modified natural language text sequence in a standardized format for the visual language understanding task (step 304).

The standardized format can be a combination of (i) a predetermined text sequence that is defined by a conversion template and (ii) the natural language text sequence. As mentioned above, the predetermined text sequence can be any text sequence that, once combined with the natural language text sequence, formats the natural language text sequence into a question format, an instructional format, or another suitable format for a visual language understanding task.

Suppose, for example, the visual language understanding task is a visual question answering (VQA) task, then the modified natural language text sequence can have a question format of “Q: what action should the robot take to [ . . . ]? A:” where [ . . . ] will be replaced by the natural language text sequence, e.g., “move cup to the wine bottle”, included in the robot control training input.

For each robot control training input, the system uses the VLM neural network to generate data, e.g., probability distribution data, that specifies a corresponding sequence of tokens for the robot control training input based on processing (i) the modified natural language text sequence, (ii) the image included in the robot control training input, or both (i) and (ii) in accordance with the parameters of the VLM neural network (step 306).

As mentioned above, the VLM neural network is trained on both robotic control tasks and visual language understanding tasks. The outputs for visual language understanding tasks may be in the format of natural language responses while the outputs for the robotic control tasks may be in the format of low-level agent control inputs.

To account for the innate difference between these two formats, for the robot control training inputs included in the batch, the system can be configured to generate sequences of tokens by selecting the tokens only from a predetermined subset of all tokens included in the predetermined vocabulary (and not from the remaining tokens included in the predetermined vocabulary that are not in the predetermined subset).

That is, for any robot control training input, the system can use the VLM neural network to generate a corresponding sequence of tokens that is made up of only tokens selected from a predetermined subset of all tokens included in the predetermined vocabulary. This ensures that a single VLM neural network can be effectively trained on both robotic control tasks and visual language understanding tasks.

In some implementations this can be achieved by performing a constrained sampling from a constrained probability distribution that is generated from an original probability distribution generated by the VLM neural network. The constrained probability distribution only includes a respective probability score for each token in the predetermined subset, and excludes a probability score for any token that is not in the predetermined subset (or instead includes a null probability score for any token that is not in the predetermined subset). In contrast, the original probability distribution generated by the VLM neural network can include a probability score for each of all of the tokens in the predetermined vocabulary.

The predetermined subset of tokens can include any, but fewer than all, tokens in the predetermined vocabulary. In some implementations, the predetermined subset of tokens can include tokens in the predetermined vocabulary that represent sign tokens (e.g., the #, $, and other signs), mathematical symbols, or numbers.

As a particular example of this, the predetermined subset of tokens can include integer tokens that represent integers, e.g., integers from 0 to 10, from 0 to 100, from 0 to 1000, or the like. The integer tokens define the action to be performed by the agent in response to the image that characterizes the environment: for each of a plurality of action dimensions of a possible action that can be performed by the agent, an integer token can represent the respective probability score assigned to each bin in the fixed number of bins for the action dimension.

In some implementations, the predetermined subset of tokens can include the least frequently used tokens in the predetermined vocabulary, e.g., the 128, 256, or 512 most infrequently used (e.g., selected) tokens when processing training data during the pre-training of the VLM neural network. Like the integer tokens, for each of a plurality of action dimensions of a possible action that can be performed by the agent, a least frequently used token can represent the respective probability score assigned to each bin in the fixed number of bins for the action dimension.

For example, the system can overwrite the least frequently used tokens to define the action to be performed by the agent, e.g., as if they were integer tokens, by using suitable token overwriting techniques, e.g., including the symbol tuning techniques discussed in Wei, Jerry, et al. “Symbol tuning improves in-context learning in language models.” arXiv preprint arXiv:2305.08298 (2023). The symbol tuning techniques utilize in-context learning to override previously learned knowledge of the VLM neural network about the tokens by processing in-context examples about the new definitions of the least frequently used tokens by using the VLM neural network.

For each robot control training input, the system generates, from the corresponding sequence of tokens, a training output for the robot control training input (step 308). The training output can include data that defines many different aspects of agent control, as will be explained further below.

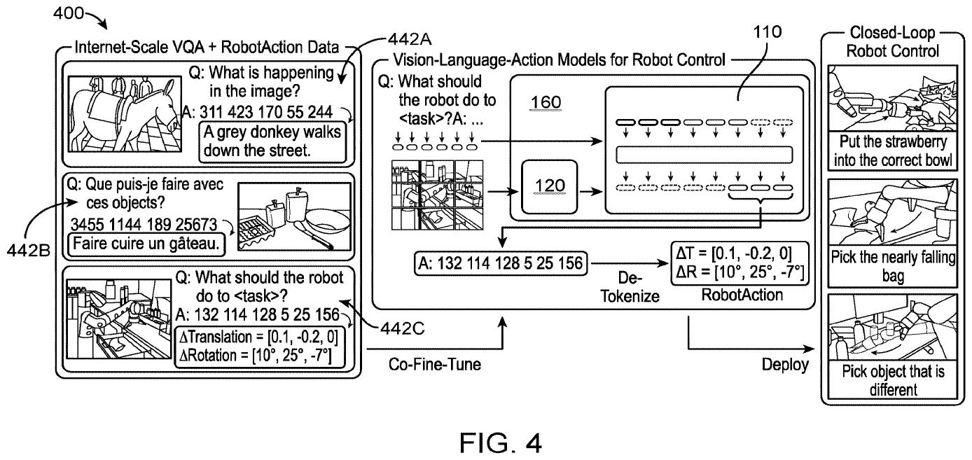

FIG. 4 is an illustration 400 of operations performed by the training system 200 to train the vision-language model (VLM) neural network 160 on one or more robotics training datasets and one or more vision-language training datasets. The VLM neural network 160, in turn, includes a text processing neural network 110 and an image processing neural network 120.

In the example of FIG. 4, the training output include data that defines a predicted action to be performed by the agent. FIG. 4 illustrates that, for a robot control training input 442C obtained from a robotics training dataset, the system uses the VLM neural network to generate the following sequence of tokens: “132 114 128 5 25 156”, where the numbers (e.g., “132”) represent the corresponding indices of tokens in the predetermined subset of the predetermined vocabulary of tokens.

The sequence of tokens include tokens that represent a total of 6 action dimensions for arm movement of the agent: x, y, z, roll, pitch, yaw. For each action dimension, the sequence of tokens include a corresponding token that defines a distribution over a fixed number of bins for the action dimension. The system thus generates, based on the sequence of tokens (“132 114 128 5 25 156”), a predicted action that includes: a translational movement of [0.1, −0.2, 0] and a rotational movement of [10°, 25°, −7°] by the arm of the agent relative to the current pose of the arm.

In some implementations, the training output can optionally include data that defines one or more other aspects of agent control. For example, the training output for the robot control training input can include a predicted natural language text sequence. The predicted natural language text sequence can be a predicted reconstruction of the natural language text sequence included in the robot control training input.

As another example, the training output for the robot control training input can include data that defines a predicted pose of the agent. A “pose” refers to the position and orientation of the agent with respect to a reference coordinate system.

As another example, the training output for the robot control training input can include data that defines a predicted number of time steps between the image included in the robot control training input and another image included in another robot control training input included in the batch.

Specifically, the robot control training inputs in each robotics training dataset can be grouped into multiple groups. Each group represents an episode of a robotic control task. An episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

The other image can, for example, be an image that is included in another robot control training input and that characterizes an initial state of the environment in an episode that also includes the robot control training input, thus the predicted number of time steps measures a length of time that the agent has spent on attempting the complete the task.

Alternatively, the other image can, for example, be an image that is included in another robot control training input and that characterizes a terminal state of the environment in an episode that also includes the robot control training input, thus the predicted number of time steps measures a length of time that is needed before the agent completes the task.

As yet another example, the training output for the robot control training input can include data that defines a prediction about whether the task was successfully accomplished by the agent when the environment is in a state characterized by the image included in the robot control training input. For example, the prediction can be a binary prediction, e.g., with 0 indicating unsuccessful and 1 indicating successful.

In these implementations, the system can use a respective head corresponding to each different aspect of agent control to process data generated by, e.g., an intermediate layer or a last layer of, the VLM neural network to generate the data defining the different aspect of agent control to be included as part of the training output. A “head” refers to a set of one or more neural network layers.

For example, an instruction head which includes one or more fully-connected layers followed by a softmax layer can be used to generate the predicted natural language text sequence. As another example, a pose head which includes one or more fully-connected layers can be used to generate the predicted pose of the agent.

The system determines, based on optimizing a robot control training objective function that is dependent on the training outputs that have been generated by the VLM neural network for the robot control training inputs included in the batch, one or more updates to current values of the parameters of the VLM neural network (step 310).

The system can do this by computing respective gradients of the robot control training objective function with respect to the parameters of the VLM neural network by backpropagation through the appropriate parameters of the VLM neural network. The system can then determine the updates by applying an update rule, e.g., an Adam update rule, an Rmsprop update rule, or a stochastic gradient descent (SGD) update rule, to the respective gradients.

The robot control training objective function can be any function that measures a quality of the training outputs generated by using the VLM neural network for the robotic control task. For example, when the training output includes data that defines a predicted action to be performed by the agent, the robot control training objective function can include a loss term that, for each robot control training input, evaluates a difference between (i) the predicted action and (ii) the target action that is defined by the target policy output included in the robot control training input.

A few auxiliary loss terms that can optionally be included in the robot control training objective function are discussed below.

As another example, when the training output includes a predicted natural language text sequence, the robot control training objective function can include a loss term that, for each robot control training input, evaluates a difference between (i) the predicted natural language text sequence and (ii) the natural language text sequence included in the robot control training input.

As another example, when the training output includes data that defines a predicted pose of the agent, the robot control training objective function can include a loss term that, for each robot control training input, evaluates a difference between (i) the predicted pose of the agent and (ii) a target pose of the agent specified by the target policy output included in the robot control training input.

As another example, when the training output includes data that defines a predicted number of time steps, the robot control training objective function can include a loss term that, for each robot control training input, evaluates a difference between (i) the predicted number of time steps and (ii) an actual number of time steps (between the image included in the robot control training input and another image included in another robot control training input included in the batch).

As yet another example, when the training output includes data that defines a prediction about whether the task was successfully accomplished by the agent, the robot control training objective function can include a loss term that, for each robot control training input, evaluates whether the prediction is correct when the environment is in a state characterized by the image included in the robot control training input.

The loss terms in these examples can be computed in any appropriate way, e.g., as a cross entropy loss term, a negative log likelihood loss term, a mean squared loss term, a L1 loss term, a L2 loss term, and so on. The robot control training objective function can also include other terms, e.g., regularization terms, auxiliary loss terms, and so on.

At each iteration of the process 300, the system performs steps 312-316 for the vision-language training inputs included in the batch. Each vision-language training input includes (i) an image, (ii) a natural language text sequence that is paired with the image, and (iii) a target vision-language task output.

For each vision-language training input, the system processes, by using the VLM neural network and in accordance with the parameters of the VLM neural network, (i) the image, (ii) the natural language text sequence, or both (i) and (ii) that are included in the vision-language training input to generate data, e.g., probability distribution data, that specifies a corresponding sequence of tokens for the vision-language training input (step 312).

Unlike when processing the robot control training inputs included in the batch, for the vision-language training input, the system can be configured to generate sequences of tokens by selecting the tokens from all tokens included in the predetermined vocabulary. That is, for any vision-language training input, the system can use the VLM neural network to generate a corresponding sequence of tokens that is made up of tokens selected from the predetermined vocabulary (including from tokens that are not in the predetermined subset).

For each vision-language training input, the system generates, from the corresponding sequence of tokens, a training output for the vision-language training input (step 314). The training output can generally be a text sequence in a natural language that is relevant to the image, the natural language text sequence, or both included in the vision-language training input.

For example, FIG. 4 illustrates that, for a vision-language training input 442A (where a natural language text sequence included in the vision-language training input is a question (“what is happening in the image”) that is posed about an image also included in the vision-language training input) obtained from a vision-language training dataset for a visual question answering (VQA) task in English, the system can use the VLM neural network to generate the following sequence of tokens: “311 423 170 55 244”, and then generates, based on the sequence of tokens, a training vision-language task output that is a predicted answer to the question: “A grey donkey walks down the street.”

As another example, FIG. 4 illustrates that, for a vision-language training input 442B (where a natural language text sequence included in the vision-language training input is a question (“Que puis-je faire avec ces objets”) that is posed about an image also included in the vision-language training input) obtained from a vision-language training dataset for a visual question answering (VQA) task in French, the system can use the VLM neural network to generate the following sequence of tokens: “3455 1144 189 25673”, and then generates, based on the sequence of tokens, a training vision-language task output that is a predicted answer to the question: “Faire cuire en gâteau.”

As a further example, for a vision-language training input obtained from a vision-language training dataset for an image captioning task, the system can use the VLM neural network to generate a training vision-language task output that is a predicted text caption for an image included in the vision-language training input.

The system determines, based on optimizing a visual language understanding training objective function, one or more updates to current values of the parameters of the VLM neural network (step 316).

The system can do this by computing respective gradients of the visual language understanding training objective function with respect to the parameters of the VLM neural network by backpropagation through the appropriate parameters of the VLM neural network. The system can then determine the updates by applying an update rule, e.g., an Adam update rule, an Rmsprop update rule, or a stochastic gradient descent (SGD) update rule, to the respective gradients.

The visual language understanding training objective function can be any function that measures a quality of the training outputs generated by the VLM neural network for the visual language understanding task(s). For example, the visual language understanding training objective function can include a loss term that evaluates, for each vision-language training input included in the batch, a difference between the training output and the target vision-language task output (e.g., a target answer or a target caption). For example, the loss term can be a cross entropy loss term or a negative log likelihood loss term that is computed with respect to each token included in the training vision-language task output. The visual language understanding training objective function can also include other terms, e.g., regularization terms, auxiliary loss terms, and so on.

After training, the training system or a different system, e.g., the policy system 100 of FIG. 1, can generate a policy neural network that includes the trained VLM neural network and deploy the policy neural network on one or more computing devices to perform one or more robotic control tasks.

Optionally, the training system or the policy system can fine-tune some or all of the parameters of the VLM neural network before deploying the policy neural network, e.g., using different robotics training dataset, using a different optimizer, or on a different objective.

Further optionally, the training system or the policy system can generate a task-specific policy neural network that includes some or all of the layers of the trained VLM neural network and a different task-specific policy head, and adapt the task-specific policy neural network to a particular robotic control task, which may or may not be the same as robotic control tasks that correspond to the robotics training datasets on which the VLM neural network has been trained.

A “head” refers to a set of one or more neural network layers. For example, the task-specific policy head can include one or more fully-connected neural network layers followed by a softmax layer. As another example, the task-specific policy head can have Transformer neural network architecture that includes one or more attention layers and a softmax layer. In either example, the task-specific policy head can be configured to process a sequence of tokens generated by the VLM neural network to generate a policy output that defines an action to be performed by the agent to perform the particular robotic control task.

For example, the training system or the policy system can use a robotics training dataset that corresponds to the particular robotic control task to adjust the parameter values of the VLM neural network learned as a result of the training, to learn new parameter values of the task-specific policy head, or both.

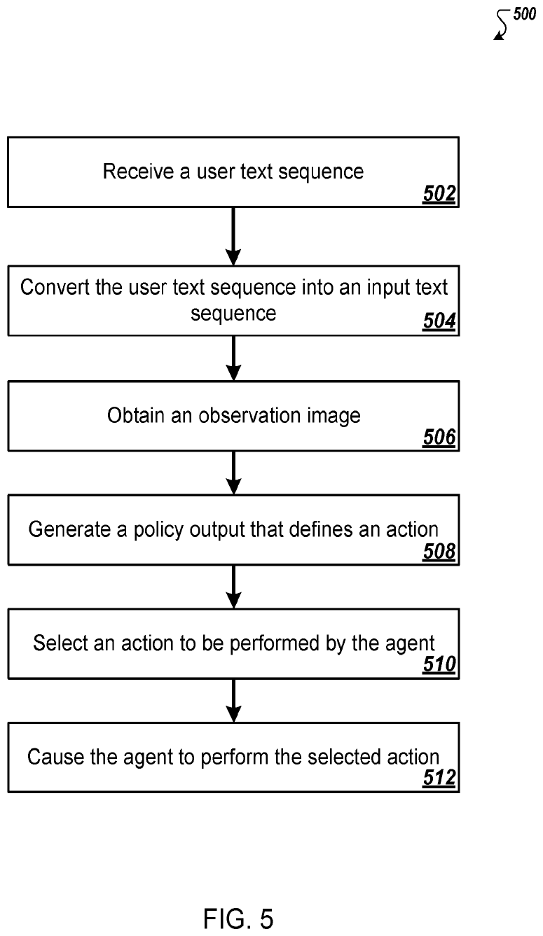

FIG. 5 is a flow diagram of an example process 500 for controlling an agent interacting with an environment. For convenience, the process 500 will be described as being performed by a system of one or more computers located in one or more locations. For example, a policy system, e.g., the policy system 100 of FIG. 1, appropriately programmed in accordance with this specification, can perform the process 500.

The system controls the agent to accomplish a task in the environment by repeatedly performing an iteration of the process 500 at each of a plurality of time steps (referred to below as the “current” time step).

The system obtains a user text sequence that characterizes a robotic task to be performed by the agent in the environment (step 502). For example, the user text sequence can specify an instruction or a command in a natural language. The user text sequence can have any of a variety of (non-standardized) formats.

In some cases, the system receives different user text sequences across the plurality of time steps. In other cases, the system receives the same user text sequence across the plurality of time steps, e.g., when the user text sequence describes a long-horizon goal for an entire episode.

For example, prior to the first iteration of the process 500, the system receives a user text sequence that characterizes the robotic task to be performed by the agent in the environment, and then stores the user text sequence in a memory device. Then, at each time step, the system fetches the stored user text sequence from the memory device.

The system obtains an input text sequence in a standardized format for a visual language understanding task (step 504). The standardized format can be a combination of (i) a predetermined text sequence and (ii) the user text sequence. The system can generate the input text sequence by converting the user text sequence into the input text sequence in accordance with a predetermined conversion template that defines the predetermined text sequence.

In some implementations, the system maintains, for each of a plurality of visual language understanding tasks (e.g., a visual question answering task, an image captioning task, a scene text understanding task, and so on), one or more predetermined conversion templates that correspond the visual language understanding task. Upon receipt of a user text sequence, the system selects a conversion template from among the predetermined conversion templates, and converts the user text sequence in accordance with the selected predetermined conversion template, which defines a predetermined text sequence, to generate the input text sequence.

In cases where the system receives the same user text sequence across the plurality of time steps, the conversion may need only be performed once at the first iteration of the process 500; the system can store the input text sequence in the memory device and, in subsequent iterations, fetch the stored input text sequence from the memory device without having to repeatedly perform the conversion at each subsequent iteration.

The system obtains an observation image characterizing a state of the environment at the current time step (step 506). For example, the observation image can be captured by a visual sensor of the agent or by a visual sensor located in the environment.

The system processes (i) the input text sequence in the standardized format and (ii) the observation image using a policy neural network to generate a policy output for the current time step (step 508). The policy neural network can include a vision-language model (VLM) neural network. The VLM neural network, in turn, can include a text processing neural network and an image processing neural network.

For example, the image processing neural network is configured to receive an image encoder input that includes the observation image, and process the image encoder input to generate an encoded image.

The text processing neural network can be configured to receive a text encoder input that includes the input text sequence and the encoded image, and process the text encoder input to generate a policy output that defines an action to be performed by the agent in response to the observation image received at the current time step.

Each possible action that can be performed by the agent is defined by a respective value for each of a plurality of action dimensions. To define the action to be performed by the agent, the policy output can include, for each of the plurality of action dimensions, one or more tokens that define a respective categorical distribution over a possible range of values for the action dimension.

For example, the system can use the policy neural network to generate the policy output that comprises a plurality of tokens generated in an auto-regressive manner by making a plurality of forward passes through the VLM neural network that is included in the policy neural network.

This is in contrast with some existing VLM-based policy systems that generate policy outputs that are high-level natural language instructions and rather than low-level agent control inputs. In the case of those existing policy systems, the policy outputs may define or otherwise specify a high-level plan for the robot (e.g., “open the drawer and remove the ball from the drawer”) or a natural language description of the action(s) to be performed by the agent (e.g., move arm to position (x, y, z)”) that cannot be directly used to control the agent: at each of the plurality of time steps, after having generated the policy output, those existing policy systems will need to further process the policy output, e.g., using another learned module, to map the policy output to the one or more low-level actions. This further processing is time-consuming and computationally costly.

The system selects an action to be performed by the agent using the policy output (step 510). This selection can be made by selecting a respective value for one or more of the plurality of action dimensions using the respective categorical distributions that are defined by the policy output of the policy neural network.

The system causes the agent to perform the selected action (step 512), e.g., by directly submitting the control input to the agent or by transmitting instructions or other data, e.g., over a data communication network, to a control system for the agent that will cause the agent to perform the selected action.

Advantageously, the system leverages the knowledge gained from large-scale datasets by the pre-trained VLM neural network to help the policy neural network to generalize when perform a robotic control task. Thus the system can perform new tasks without any additional training.

For example after having been trained to move or manipulate some objects, the system can move or manipulate a new object without any previous training that has involved robotic control tasks relating to that object, e.g., without the new object having been depicted in any images or without a natural language identifying the new object having been included in any task-related instructions during the training on robotics training datasets.

The system can generalize to unseen objects using knowledge gained through training on at least one visual language understanding task (e.g., a visual question answering task or an image captioning task). Thus, the system can perform robotic control tasks that involve new objects.

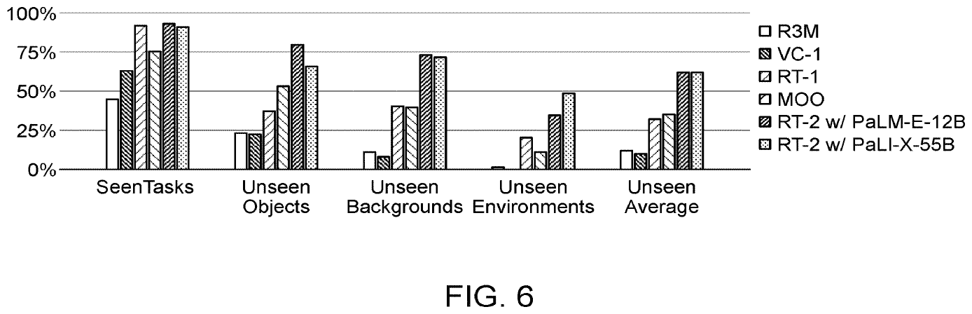

FIG. 6 shows a quantitative example of the performance gains that can be achieved by using a policy system described in this specification. Specifically, FIG. 6 shows overall performance of an agent (in term of success rate) controlled using the policy system 100 of FIG. 1 (“RT-2”) and agents controlled using baseline systems across seen tasks, generalization capability to tasks that involve unseen objects, unseen backgrounds, and unseen environments.

“RT-2 w/PaLI-X-55B” represents an implementation of the policy system 100 that includes a VLM neural network having an architecture described in X. Chen, et al. Pali-x: On scaling up a multilingual vision and language model, 2023. “RT-2 w/PaLM-E-12B” is represents another implementation of the policy system 100 that includes a VLM neural network having an architecture described in D. Driess, et al. Palm-e: An embodied multimodal language model. arXiv preprint arXiv:2303.03378, 2023.

The baseline systems include a R3M system (described in S. Nair, et al. R3m: A universal visual representation for robot manipulation. arXiv preprint arXiv:2203.12601, 2022), a VC-1 system (described in A. Majumdar, et al. Where are we in the search for an artificial visual cortex for embodied intelligence? arXiv preprint arXiv:2303.18240, 2023), a RT-1 system (described in A. Brohan, et al. Rt-1: Robotics transformer for real-world control at scale. arXiv preprint arXiv:2212.06817, 2022), and a MOO system (described in A. Stone, et al. Open-world object manipulation using pre-trained vision-language models. arXiv preprint arXiv:2303.00905, 2023).

In FIG. 6, “seen tasks” are tasks that were seen during training, i.e., tasks on which the policy system has been trained: “unseen objects” are tasks that involve novel objects that were previously unseen in the training dataset; and “unseen backgrounds” are tasks that involve an environment having previously unseen backgrounds, e.g., backgrounds with different scenes or different illuminations); and “unseen environments” are tasks that involve novel environments that were previously unseen in the training dataset.

It can be appreciated that, the performance on seen tasks is similar between the policy system 100 and RT-1 system, with other baseline systems attaining a lower success rate. The policy system 100 outperforms the baseline systems by larger margins on other tasks. on average, both implementations of the policy system 100 achieves ~2× improvement over the next two baseline systems, RT-1 system and MOO system, and ~6× improvement over the other baseline systems. The PaLM-E implementation of the policy system 100 achieves better performance than the PaLI-X implementation of the policy system 100 in more difficult versions of generalization scenarios while under-performing on easier ones, attaining in a similar performance on average.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine: in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

This specification also provides the subject-matter of the following clauses:

Clause 1. A method performed by one or more computers and for controlling an agent interacting with an environment, the method comprising:
receiving a user text sequence that characterizes a robotic task to be performed by the agent in the environment;
converting the user text sequence into an input text sequence in a standardized format for a visual language understanding task;
obtaining an observation image characterizing a state of the environment;
processing (i) the input text sequence in the standardized format and (ii) the observation image using a policy neural network to generate a policy output that defines an action to be performed by the agent in response to the observation image;
selecting an action to be performed by the agent using the policy output; and
causing the agent to perform the selected action.

Clause 2. The method of clause 1, wherein converting the user text sequence into the input text sequence in the standardized format comprises:
maintaining one or more predetermined conversion templates that correspond respectively to different visual language understanding task;
selecting a selected predetermined conversion template from among the one or more predetermined conversion templates; and
converting the user text sequence in accordance with the selected predetermined conversion template.

Clause 3. The method of clause 2, wherein converting the user text sequence in accordance with the selected predetermined conversion templates comprises:
adding a predetermined text sequence to the user text sequence.

Clause 4. The method of any one of clauses 1-3, wherein the visual language understanding task comprises a visual question answering (VQA) task, and wherein the standardized format is a question format.

Clause 5. The method of any one of clauses 1-4, wherein the policy neural network comprises a vision-language model (VLM) neural network that includes an image encoder neural network and a text encoder neural network, and wherein processing (i) the input text sequence in the standardized format and (ii) the observation image using the policy neural network comprises:
processing the observation image using the image encoder neural network to generate an encoded representation of the observation image; and
processing the input text sequence using the text encoder neural network to generate an encoded representation of the input text sequence.

Clause 6. The method of any one of clauses 1-4 when also dependent on clause 5, wherein the policy neural network further comprises a Transformer neural network, and wherein processing (i) the input text sequence in the standardized format and (ii) the observation image using the policy neural network further comprises:
generating, from the encoded representation of the observation image and the encoded representation of the input text sequence, a sequence of input tokens; and
processing the sequence of input tokens using the Transformer neural network to generate the policy output.

Clause 7. The method of any one of clauses 1-6, wherein the policy output comprises, for each of a plurality of action dimensions, a respective categorical distribution over possible values for the action dimensions.

Clause 8. The method of clause 7, wherein selecting the action to be performed by the agent using the policy output comprises selecting a respective value for one or more of the action dimensions using the respective categorical distributions.

Clause 9. A computer-implemented method comprising:
obtaining a robotics training dataset that comprises a plurality of robot control training inputs, each robot control training input comprising (i) an image that characterizes an environment, (ii) a natural language text sequence that characterizes a task to be performed by an agent in the environment, and (iii) a target policy output that defines an action to be performed by the agent;
obtaining a vision-language training dataset that comprises a plurality of vision-language training inputs, each vision-language training input comprising (i) an image, (ii) a natural language text sequence that is paired with the image, and (iii) a target vision-language task output;
training a vision-language model (VLM) neural network on both the robotics training dataset and the vision-language training dataset, wherein the training comprises:
   obtaining a batch of training inputs that include one or more robot control training inputs;
   for each robot control training input included in the batch, generating, from a natural language text sequence included in the robot control training input, a modified natural language text sequence in a standardized format for the visual language understanding task;
   for each robot control training input included in the batch, processing, by the VLM neural network, (i) the modified natural language text sequence that has been generated for the robot control training input, (ii) the image included in the robot control training input, or both (i) and (ii), to generate a corresponding sequence of tokens for the robot control training input;
   generating, from the corresponding sequence of tokens, a training output for the robot control training input; and
   determining one or more updates to parameter values of the VLM neural network based on optimizing a training objective function that is dependent on the training output.

Clause 10. The method of clause 9, wherein the batch of training inputs also include one or more vision-language training inputs, and wherein the training comprises:
for each vision-language training input included in the batch, processing, by the VLM neural network, (i) the image, (ii) the natural language text sequence, or both (i) and (ii) that are included in the vision-language training input to generate a corresponding sequence of tokens for the vision-language training input;
for each vision-language training input included in the batch, generating, from the corresponding sequence of tokens, a training vision-language task output for the robot control training input; and
determining one or more updates to parameter values of the VLM neural network based on optimizing a training objective function that evaluates a difference between the training vision-language task output and the target vision-language task output.

Clause 11. The method of any one of clause 9 or 10, wherein for each vision-language training input included in the batch, the corresponding sequence of tokens are selected from all tokens included in a token vocabulary, and wherein for each robot control training input included in the batch, the corresponding sequence of tokens are selected from a predetermined subset of all tokens included in the token vocabulary.

Clause 12. The method of any one of clauses 9-11, wherein training the VLM neural network comprises training the VLM neural network starting from pre-trained parameter values learned as a result of pre-training the VLM neural network on one or more multimodal understanding task pre-training datasets comprising one or more of: a visual-question answering dataset, an image captioning dataset, or a scene text understanding dataset.

Clause 13. The method of any one of clauses 9-11, wherein training the VLM neural network comprises training the VLM neural network starting from pre-trained parameter values learned as a result of pre-training the VLM neural network on one or more robotics pre-training datasets.

Clause 14. The method of any one of clauses 9-13, wherein the VLM neural network has pre-trained parameter values learned as a result of optimizing a next token prediction objective during the pre-training.

Clause 15. The method of any one of clauses 9-14, wherein obtaining the batch of training inputs comprises:
sampling, in accordance with respective sampling weights assigned to the robotics training dataset and the vision-language training dataset, the batch of training inputs from the robotics training dataset and the vision-language training dataset.

Clause 16. The method of clause 15, wherein the sampling weight assigned to the robotics training dataset is higher than the sampling weight assigned to the vision-language training dataset.

Clause 17. The method of any one of clauses 9-16, wherein the training output for the robot control training input comprises a predicted action to be performed by the agent, and wherein the training objective function evaluates a difference between the predicted action and a target action specified by the target policy output included in the robot control training input.

Clause 18. The method of any one of clauses 9-16, wherein the training output for the robot control training input comprises a predicted natural language text sequence, and wherein the training objective function evaluates a difference between the predicted natural language text sequence and the natural language text sequence included in the robot control training input.

Clause 19. The method of any one of clauses 9-16, wherein the training output for the robot control training input comprises a predicted pose of the agent, and wherein the training objective function evaluates a difference between the predicted pose of the agent and a target pose of the agent specified by the target policy output included in the robot control training input.

Clause 20. The method of any one of clauses 9-16, wherein the training output for the robot control training input comprises a predicted number of time steps between the image included in the robot control training input and another image included in another robot control training input included in the batch, and wherein the training objective function evaluates a difference between the predicted number of time steps and an actual number of time steps.

Clause 21. The method of any one of clauses 9-16, wherein the training output for the robot control training input comprises a prediction about whether the task was successfully accomplished by the agent, and wherein the training objective function evaluates whether the prediction is correct when the environment is in a state characterized by the image included in the robot control training input.

Clause 22. The method of any one of clauses 9-16, wherein the training vision-language task output comprises a predicted answer to a question that is specified by the natural language text sequence and that is posed about the image included in the vision-language training input.

Clause 23. The method of any one of clauses 9-16, wherein the training vision-language task output comprises a predicted text caption for the image included in the vision-language training input.

Clause 24. The method of any one of clauses 17-23, wherein training the VLM neural network comprises:
generating a training task-specific policy neural network that includes the VLM neural network and a respective training output head that is specific to each of the training objective functions.

Clause 25. The method of any one of clauses 9-24, further comprising:
after the training, performing a particular agent control task using the trained VLM neural network.

Clause 26. The method of clause 25, wherein performing the particular agent control task using the trained VLM neural network comprises:
generating an inference task-specific policy neural network that includes the VLM neural network and an inference output head that is specific to the particular agent control task; and
using the inference task-specific policy neural network to perform the particular agent control task.

Clause 27. The method of clause 26, wherein using the inference task-specific policy neural network to perform the particular agent control task comprises:
adapting the inference task-specific policy neural network to the particular agent control task, including adjusting the parameter values of the VLM neural network learned as a result of the training, learning new parameter values of the inference output head, or both.

Clause 28. The method of any one of clauses 26-27, wherein the inference output head comprises a Transformer neural network that processes a sequence of tokens generated by the VLM neural network to generate a policy output that defines an action to be performed by the agent.

Clause 29. A system comprising one or more computers and one or more storage devices storing instructions that when executed by the one or more computers cause the one more computers to perform the operations of the respective method of any one of clauses 1-28.

Clause 30. One or more computer storage media storing instructions that when executed by one or more computers cause the one more computers to perform the operations of the respective method of any one of clauses 1-28.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for controlling an agent interacting with an environment, the method comprising:
receiving a user text sequence that characterizes a robotic task to be performed by the agent in the environment;
converting the user text sequence into an input text sequence in a standardized format for a visual language understanding task;
obtaining an observation image characterizing a state of the environment;
processing (i) the input text sequence in the standardized format and (ii) the observation image using a policy neural network to generate a policy output that defines an action to be performed by the agent in response to the observation image;
selecting an action to be performed by the agent using the policy output; and
causing the agent to perform the selected action.

2. The method of claim 1, wherein converting the user text sequence into the input text sequence in the standardized format comprises:
maintaining one or more predetermined conversion templates that correspond respectively to different visual language understanding tasks;
selecting a selected predetermined conversion template from among the one or more predetermined conversion templates; and
converting the user text sequence in accordance with the selected predetermined conversion template.

3. The method of claim 2, wherein converting the user text sequence in accordance with the selected predetermined conversion templates comprises:
adding a predetermined text sequence to the user text sequence.

4. The method of claim 1, wherein the visual language understanding task comprises a visual question answering (VQA) task, and wherein the standardized format is a question format.

5. The method of claim 1, wherein the policy neural network comprises a vision-language model (VLM) neural network that includes an image processing neural network and a text processing neural network, and wherein processing (i) the input text sequence in the standardized format and (ii) the observation image using the policy neural network comprises:
processing the observation image using the image processing neural network to generate an encoded representation of the observation image; and
processing the input text sequence using the text processing neural network to generate an encoded representation of the input text sequence.

6. The method of claim 5, further comprising:
processing the encoded representation of the input text sequence and the encoded representation of the observation image using the text processing neural network to generate the policy output.

7. The method of claim 1, wherein the policy output comprises, for each of a plurality of action dimensions, a respective categorical distribution over possible values for the action dimension.

8. The method of claim 7, wherein selecting the action to be performed by the agent using the policy output comprises selecting a respective value for one or more of the action dimensions using the respective categorical distributions.

9. A computer-implemented method comprising:
obtaining a robotics training dataset that comprises a plurality of robot control training inputs, each robot control training input comprising (i) an image that characterizes an environment, (ii) a natural language text sequence that characterizes a task to be performed by an agent in the environment, and (iii) a target policy output that defines an action to be performed by the agent;
obtaining a vision-language training dataset that comprises a plurality of vision-language training inputs, each vision-language training input comprising (i) an image, (ii) a natural language text sequence that is paired with the image, and (iii) a target vision-language task output;
training a vision-language model (VLM) neural network on both the robotics training dataset and the vision-language training dataset, wherein the training comprises:
obtaining a batch of training inputs that include one or more robot control training inputs;
for each robot control training input included in the batch, generating, from a natural language text sequence included in the robot control training input, a modified natural language text sequence in a standardized format for the visual language understanding task;
for each robot control training input included in the batch, processing, by the VLM neural network, (i) the modified natural language text sequence that has been generated for the robot control training input, (ii) the image included in the robot control training input, or both (i) and (ii), to generate a corresponding sequence of tokens for the robot control training input;
generating, from the corresponding sequence of tokens, a training output for the robot control training input; and
determining one or more updates to parameter values of the VLM neural network based on optimizing a training objective function that is dependent on the training output.

10. The method of claim 9, wherein the batch of training inputs also include one or more vision-language training inputs, and wherein the training comprises:
for each vision-language training input included in the batch, processing, by the VLM neural network, (i) the image, (ii) the natural language text sequence, or both (i) and (ii) that are included in the vision-language training input to generate a corresponding sequence of tokens for the vision-language training input;
for each vision-language training input included in the batch, generating, from the corresponding sequence of tokens, a training output for the vision-language training input; and
determining one or more updates to parameter values of the VLM neural network based on optimizing a training objective function that evaluates a difference between the training output and the target vision-language task output.

11. The method of claim 9, wherein for each vision-language training input included in the batch, the corresponding sequence of tokens are selected from all tokens included in a token vocabulary, and wherein for each robot control training input included in the batch, the corresponding sequence of tokens are selected from a predetermined subset of all tokens included in the token vocabulary.

12. The method of claim 9, wherein training the VLM neural network comprises training the VLM neural network starting from pre-trained parameter values learned as a result of pre-training the VLM neural network on one or more multimodal understanding task pre-training datasets comprising one or more of: a visual-question answering dataset, an image captioning dataset, or a scene text understanding dataset.

13. The method of claim 9, wherein training the VLM neural network comprises training the VLM neural network starting from pre-trained parameter values learned as a result of pre-training the VLM neural network on one or more robotics pre-training datasets.

14. The method of claim 9, wherein the VLM neural network has pre-trained parameter values learned as a result of optimizing a next token prediction objective during the pre-training.

15. The method of claim 9, wherein obtaining the batch of training inputs comprises:
sampling, in accordance with respective sampling weights assigned to the robotics training dataset and the vision-language training dataset, the batch of training inputs from the robotics training dataset and the vision-language training dataset.

16. The method of claim 15, wherein the sampling weight assigned to the robotics training dataset is higher than the sampling weight assigned to the vision-language training dataset.

17. The method of claim 9, wherein the training output for the robot control training input comprises data defining a predicted action to be performed by the agent, and wherein the training objective function evaluates a difference between the predicted action and a target action defined by the target policy output included in the robot control training input.

18. The method of claim 9, wherein the training output for the robot control training input comprises a predicted natural language text sequence, and wherein the training objective function evaluates a difference between the predicted natural language text sequence and the natural language text sequence included in the robot control training input.

19. The method of claim 9, wherein the training output for the robot control training input comprises data defining a predicted pose of the agent, and wherein the training objective function evaluates a difference between the predicted pose of the agent and a target pose of the agent specified by the target policy output included in the robot control training input.

20. The method of claim 9, wherein the training output for the robot control training input comprises data defining a predicted number of time steps between the image included in the robot control training input and another image included in another robot control training input included in the batch, and wherein the training objective function evaluates a difference between the predicted number of time steps and an actual number of time steps.

21. The method of claim 9, wherein the training output for the robot control training input comprises a prediction about whether the task was successfully accomplished by the agent, and wherein the training objective function evaluates whether the prediction is correct when the environment is in a state characterized by the image included in the robot control training input.

22. The method of claim 9, wherein the training vision-language task output comprises a predicted answer to a question that is specified by the natural language text sequence and that is posed about the image included in the vision-language training input.

23. The method of claim 9, wherein the training vision-language task output comprises a predicted text caption for the image included in the vision-language training input.

24. The method of claim 17, wherein training the VLM neural network comprises:
generating a training task-specific policy neural network that includes the VLM neural network and a respective training output head that is specific to each of the training objective functions.

25. The method of claim 9, further comprising:
after the training, performing a particular agent control task using the trained VLM neural network.

26. The method of claim 25, wherein performing the particular agent control task using the trained VLM neural network comprises:
generating an inference task-specific policy neural network that includes the VLM neural network and an inference output head that is specific to the particular agent control task; and
using the inference task-specific policy neural network to perform the particular agent control task.

27. The method of claim 26, wherein using the inference task-specific policy neural network to perform the particular agent control task comprises:
adapting the inference task-specific policy neural network to the particular agent control task, including adjusting the parameter values of the VLM neural network learned as a result of the training, learning new parameter values of the inference output head, or both.

28. The method of claim 26, wherein the inference output head comprises a Transformer neural network that processes a sequence of tokens generated by the VLM neural network to generate a policy output that defines an action to be performed by the agent.

29. A system comprising one or more computers and one or more storage devices storing instructions that when executed by the one or more computers cause the one more computers to perform operations for controlling an agent interacting with an environment, the operations comprising:
receiving a user text sequence that characterizes a robotic task to be performed by the agent in the environment;
converting the user text sequence into an input text sequence in a standardized format for a visual language understanding task;
obtaining an observation image characterizing a state of the environment;
processing (i) the input text sequence in the standardized format and (ii) the observation image using a policy neural network to generate a policy output that defines an action to be performed by the agent in response to the observation image;
selecting an action to be performed by the agent using the policy output; and
causing the agent to perform the selected action.

30. (canceled)
